(19) United States
(12) Patent Application Publication
(10) Pub. No.: US 2025/0381733 A1
(43) Pub. Date: Dec. 18, 2025

(54) 3D PRINTING DEVICE, LIGHT CONTROL MODULE AND OPERATION METHOD OF 3D PRINTING DEVICE

(71) Applicant: Innolux Corporation, Miaoli County (TW)

(72) Inventors: Chieh-Hsiang Hsu, Miaoli County (TW); Ming-Chu Hu, Miaoli County (TW); Tsung-Che Lu, Miaoli County (TW); Chiu-Ju Chu, Miaoli County (TW); Chang-Heng Tsai, Miaoli County (TW)

(73) Assignee: Innolux Corporation, Miaoli County (TW)

(21) Appl. No.: 19/204,657

(22) Filed: May 12, 2025

Related U.S. Application Data
(60) Provisional application No. 63/659,336, filed on Jun. 13, 2024.

(30) Foreign Application Priority Data
Nov. 19, 2024 (CN) 202411657118.1

(51) Int. Cl. B29C 64/264; B29C 64/129; B33Y 10/00; B33Y 30/00; G02B 5/30

(52) U.S. Cl. CPC B29C 64/264; B29C 64/129; B33Y 10/00; B33Y 30/00; G02B 5/30

(57) ABSTRACT

A 3D printing device includes a light control module, a light source module, and a receiving slot. The light source module provides a light beam to the light control module. The receiving slot receives a photo-curing material. The light control module is between the light source module and the receiving slot. The photo-curing material is cured by the light beam. The light control module includes first and second substrates, a dielectric layer, and a polarizing element. The first substrate has outer and inner surfaces opposite to each other. The second substrate is opposite to the first substrate. The dielectric layer is between the inner surface of the first substrate and the second substrate. The polarizing element is on the outer surface of the first substrate. A polarization degree of the polarizing element for a light beam having a wavelength range of 375 nm to 405 nm is 98% to 100%.

### CROSS-REFERENCE TO RELATED APPLICATION

This application claims the priority benefits of U.S. provisional application Ser. No. 63/659,336, filed on Jun. 13, 2024, and China application serial no. 202411657118.1, filed on Nov. 19, 2024. The entirety of each of the above-mentioned patent applications is hereby incorporated by reference herein and made a part of this specification.

### BACKGROUND

### Technical Field

The disclosure relates to a 3d printing device, a light control module, and an operation method of a 3d printing device.

### Description of Related Art

A three-dimensional printing device may use a light control module as a mask. The mask opening in the light control module is electronically controlled to allow UV light to pass through, thereby curing the photo-curing material in the receiving slot.

In the current 3D printing device, a light source having a wavelength of 405 nm is used for printing. However, the light source having a wavelength of 405 nm may have insufficient energy, which is not conducive to the production of a printed product having a fine pattern (for example, a medical model). The medical model may be, for example, a skeleton model. Therefore, it is desirable to develop a new light control module suitable for printing with a light source having a shorter wavelength (higher energy).

### SUMMARY

Some embodiments of the disclosure are directed to a light control module having relatively good polarization degree.

A light control module provided by some embodiments of the disclosure includes a first substrate, a second substrate, a dielectric layer, and a polarizing element. The first substrate has an outer surface and an inner surface opposite to the outer surface. The second substrate is opposite to the first substrate. The dielectric layer is disposed between the inner surface of the first substrate and the second substrate. The polarizing element is disposed on the outer surface of the first substrate, wherein a polarization degree of the polarizing element for a light beam having a wavelength range of 375 nm to 405 nm is 98% to 100%.

Some other embodiments of the disclosure are directed to a three-dimensional printing device that may print a product having relatively good quality.

A three-dimensional printing device provided according to some other embodiments of the disclosure includes the light control module, the light source module, and the receiving slot of the above embodiment. The light source module is used to provide a light beam to the light control module. The receiving slot is used to receive a photo-curing material, wherein the light control module is disposed between the light source module and the receiving slot, and the photo-curing material is cured by the light beam.

Some other embodiments of the disclosure are directed to an operation method of a three-dimensional printing device that may print a product having relatively good quality.

An operation method of a three-dimensional printing device provided according to some other embodiments of the disclosure includes the following steps. The three-dimensional printing device of the above embodiment is provided. A photo-curing material is disposed in a receiving slot. The light source module is made to provide a light beam. The light control module is made to provide a first light-transmitting area and a first light-shielding area. The light beam is made to pass through the first light-transmitting area of the light control module. A first portion of the photo-curing material corresponding to the first light-transmitting area is cured into a first cured layer via the light beam.

In order to make the aforementioned features and advantages of the disclosure more comprehensible, embodiments accompanied with figures are described in detail below.

### BRIEF DESCRIPTION OF THE DRAWINGS

FIG. 1A is a partial top schematic view of a light control module in a three-dimensional printing device of an embodiment of the disclosure.

FIG. 1B is a partial cross-sectional schematic view of a light control module in a three-dimensional printing device of an embodiment of the disclosure.

FIG. 2A is a graph showing the relationship between the wavelength of a light beam and the polarization degree of a polarizing element in a light control module of some embodiments of the disclosure.

FIG. 2B is an enlarged schematic view of a region R1 in FIG. 2A.

FIG. 2C is a graph showing the relationship between the wavelength of a light beam and the transmittance of a polarizing element in a light control module of some embodiments of the disclosure.

FIG. 2D is an enlarged view of a region R2 in FIG. 2C.

FIG. 3A, FIG. 4A, and FIG. 5A are each a flowchart of an operation method of a three-dimensional printing device according to an embodiment of the disclosure.

FIG. 3B, FIG. 4B, and FIG. 5B are each a top schematic view of an image displayed by the light control modules in FIG. 3A, FIG. 4A, and FIG. 5A.

FIG. 6 is a schematic view of a product obtained by three-dimensional printing via a three-dimensional printing device of an embodiment of the disclosure.

### DESCRIPTION OF THE EMBODIMENTS

Reference will now be made in detail to the exemplary embodiments of the disclosure, and examples of the exemplary embodiments are illustrated in the accompanying drawings. Wherever possible, the same reference numerals are used in the figures and the descriptions to refer to the same or similar portions.

Throughout the disclosure, certain words are used to refer to specific elements in the specification and the claims. Those skilled in the art should understand that electronic device manufacturers may refer to the same elements by different names. The specification does not intend to distinguish between elements having the same function but different names. In the following specification and claims, the words “contain” and “include” and the like are open-ended words, and therefore should be interpreted as “including but not limited to . . . ”

The directional terms mentioned herein, such as “upper”, “lower”, “front”, “rear”, “left”, “right”, etc., refer to the directions of the drawings. Accordingly, the directional terms used are illustrative, not limiting, of the disclosure. In the drawings, each drawing depicts general features of methods, structures, and/or materials used in specific embodiments. However, the drawings should not be interpreted as defining or limiting the scope or nature encompassed by the embodiments. For example, the relative sizes, thicknesses, and locations of various layers, regions, and/or structures may be reduced or exaggerated for clarity.

When one structure (or layer, element, or substrate) described in the disclosure is located on/above another structure (or layer, element, or substrate), it may mean that the two structures are adjacent and directly connected, or may mean that the two structures are adjacent rather than directly connected. Indirect connection means that there is at least one intermediary structure (or intermediary layer, intermediary element, intermediary substrate, or intermediary spacer) between the two structures. The lower surface of one structure is adjacent to or directly connected to the upper surface of the intermediary structure, and the upper surface of the other structure is adjacent to or directly connected to the lower surface of the intermediary structure. The intermediary structure may be formed by a single-layer or multi-layer physical structure or a non-physical structure, and there is no limit. In the disclosure, when a structure is disposed “on” another structure, it may mean that a certain structure is “directly” on another structure, or that a certain structure is “indirectly” on another structures, that is, there is at least one structure sandwiched between a certain structure and another structure.

The terms “about”, “equal to”, “equal” or “same”, “substantially” or “essentially” are generally interpreted as within 20% of the given value or range, or interpreted as within 10%, 5%, 3%, 2%, 1%, or 0.5% of a given value or range. Moreover, the terms “the range is from the first value to the second value” and “the range is between the first value and the second value” mean that the range includes the first value, the second value, and other values in between.

Words such as “first” and “second” used in the specification and claims are used to modify elements, which do not themselves imply and represent that the (or these) elements have any previous ordinal numbers, nor do they imply an order of a certain element with another element, or an order in manufacturing methods. These ordinal numbers are used to clearly distinguish an element having a certain designation from another element having the same designation. The same wording may be not used in the claims and the specification. Accordingly, the first member in the specification may be the second member in the claims.

The electrical connection or coupling described in the disclosure may both refer to direct connection or indirect connection. In the case of direct connection, the terminals of elements on two circuits are connected directly or to each other by a conductor segment. In the case of indirect connection, there is a switch, a diode, a capacitor, an inductor, a resistor, other suitable elements, or a combination of the above elements between the terminals of the elements on the two circuits, but the disclosure is not limited thereto.

In the disclosure, the thickness, the length, and the width may be measured using an optical microscope (OM), and the thickness or the width may be measured using a cross-sectional image in an electron microscope, but the disclosure is not limited thereto. In addition, any two values or directions used for comparison may have certain errors. In addition, the terms “equal to”, “same as”, “the same”, “substantially”, or “about” mentioned in the disclosure generally mean falling within 10% of a given value or range. Moreover, the terms “the given range is from the first value to the second value”, “the given range falls within the range from the first value to the second value”, or “the given range is between the first value and the second value” mean that the given range includes the first value, the second value, and other values in between. If the first direction is perpendicular to the second direction, the angle between the first direction and the second direction may be between 80 degrees and 100 degrees; if the first direction is parallel to the second direction, the angle between the first direction and the second direction may be between 0 degrees and 10 degrees.

It should be noted that, in the following embodiments, without departing from the spirit of the disclosure, features in several different embodiments may be replaced, reorganized, and mixed to complete other embodiments. As long as the features of the various embodiments do not violate the spirit of the disclosure or conflict each other, they may be mixed and matched arbitrarily.

Unless otherwise defined, all terms (including technical and scientific terms) used herein have the same meaning as commonly understood by those skilled in the art to which this disclosure belongs. It may be understood that these terms, such as those defined in commonly used dictionaries, should be interpreted as having a meaning consistent with the background or the context of the related techniques and the disclosure, and should not be interpreted in an idealized or overly formal manner, unless otherwise defined in the embodiments of the disclosure.

In the disclosure, an electronic device may include a three-dimensional printing device, a display device, a backlight device, an antenna device, a sensing device, or a tiling device, but the disclosure is not limited thereto. The electronic device may be a bendable or flexible electronic device. The three-dimensional printing device may be a printing device adopting a stereolithography technique, a digital light processing (DLP) technique, or a liquid-crystal display (LCD) light curing technique. The display device may be a non-self-luminous display device or a self-luminous display device. The backlight device may include, for example, liquid crystal, light-emitting diode, fluorescence, phosphor, quantum dot (QD), other suitable display media, or a combination of the above. The antenna device may include, for example, a frequency selective surface (FSS), a radio frequency filter (RF filter), a polarizer, a resonator, or an antenna, etc. The antenna may be a liquid-crystal-type antenna or a non-liquid-crystal-type antenna. The sensing device may be a sensing device sensing capacitance, light, heat energy, or ultrasonic waves, but the disclosure is not limited thereto. In the disclosure, the electronic device may include an electronic element, and the electronic element may include a passive element and an active element, such as a capacitor, a resistor, an inductor, a diode, a transistor, etc. The diode may include a light-emitting diode or a photodiode. The light-emitting diode may include, for example, an organic light-emitting diode (OLED), a mini LED, a micro LED, or a quantum dot LED, but the disclosure is not limited thereto. The tiling device may be, for example, a display tiling device or an antenna tiling device, but the disclosure is not limited thereto. It should be noted that the electronic device may be any arrangement and combination of the above, but the disclosure is not limited thereto. Moreover, the shape of the electronic device may be rectangular, circular, polygonal, a shape having curved edges, or other suitable shapes. The electronic device may have a peripheral system such as a driving system, a control system, and a light source system to support a display device, an antenna device, a wearable device (for example, including augmented reality or virtual reality), a vehicle-mounted device (for example, including a car windshield), or a tiling device.

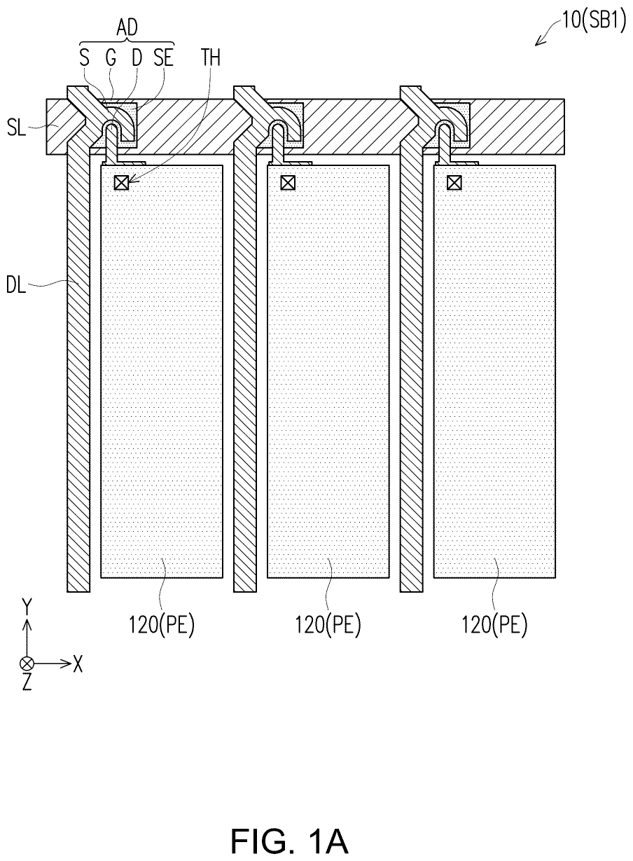

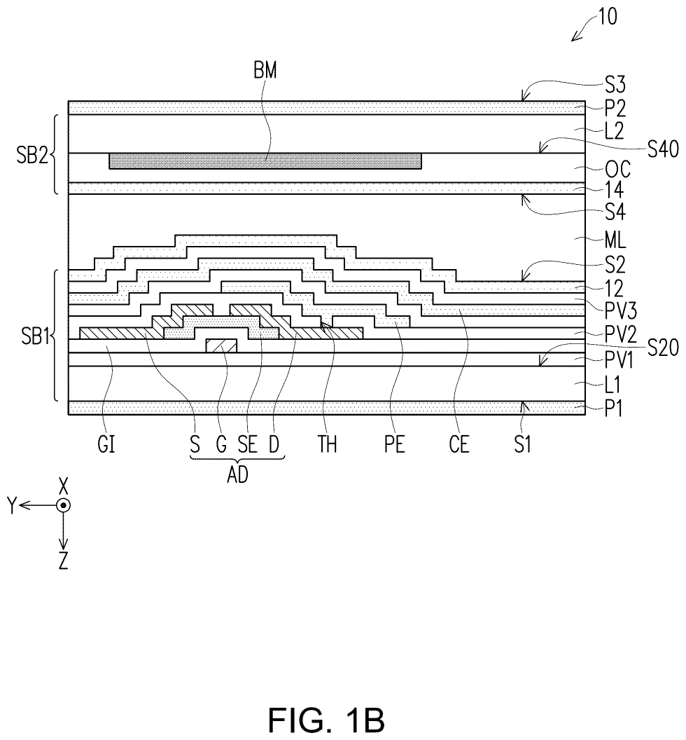

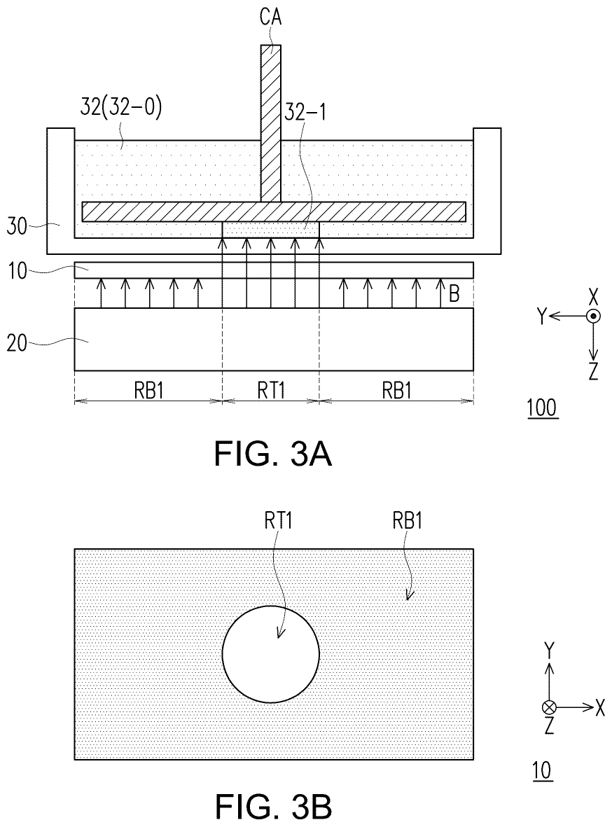

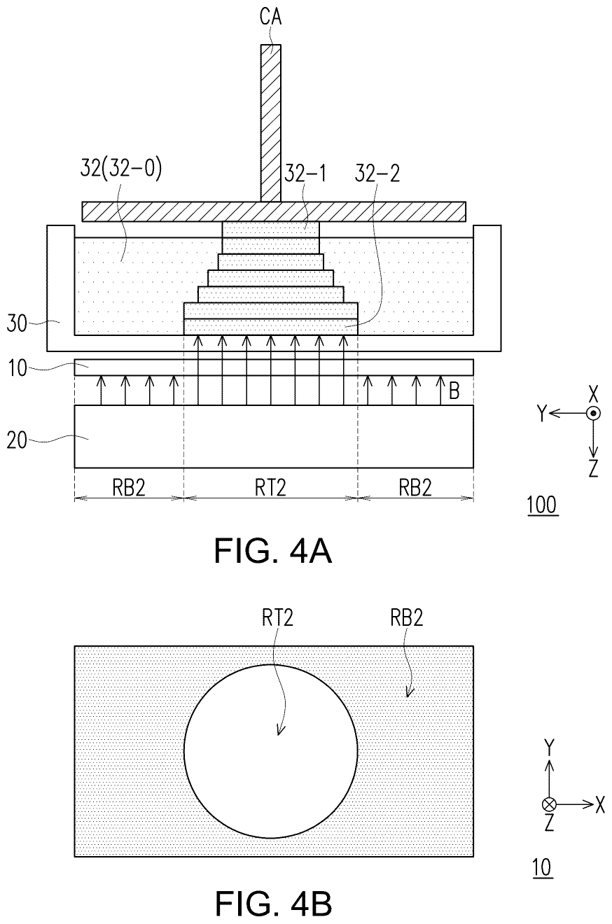

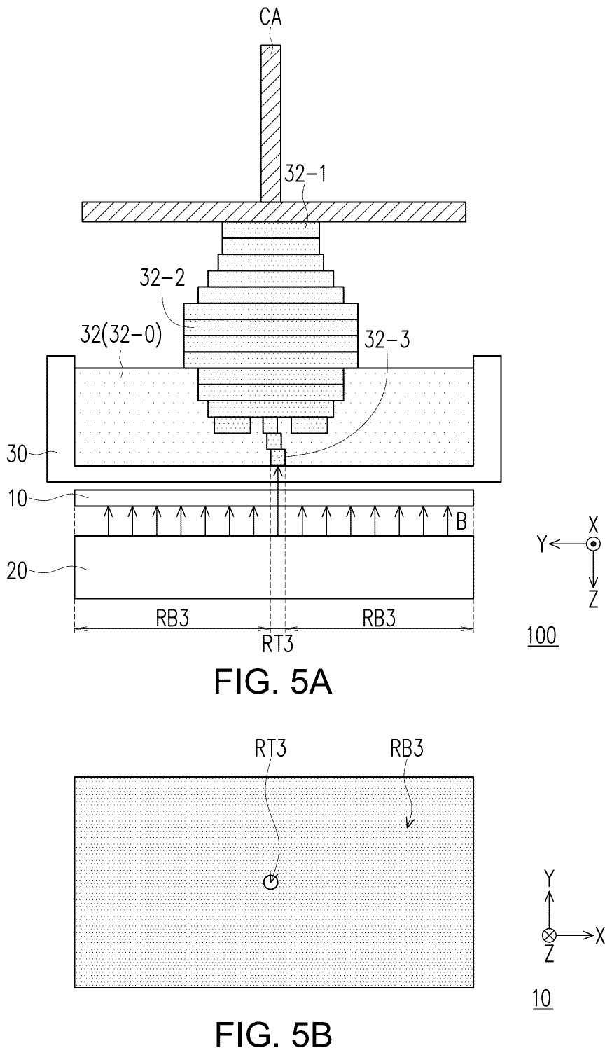

FIG. 1A is a partial top schematic view of a light control module in a three-dimensional printing device of an embodiment of the disclosure, FIG. 1B is a partial cross-sectional schematic view of a light control module in a three-dimensional printing device of an embodiment of the disclosure, and FIG. 3A shows a cross-sectional schematic view of a three-dimensional printing device of an embodiment of the disclosure.

Referring to FIG. 3A, a three-dimensional printing device 100 of the present embodiment includes a light control module 10, a light source module 20, and a receiving slot 30.

Please refer to FIG. 1B. In the present embodiment, the light control module 10 includes a first substrate SB1, a second substrate SB2, a dielectric layer ML, and a polarizing element P1.

As shown in FIG. 1B, the first substrate SB1 has, for example, an outer surface S1 and an inner surface S2 opposite to the outer surface S1. The outer surface S1 of the first substrate SB1 may be a surface away from the second substrate SB2, and the inner surface S2 may be a surface facing the second substrate SB2. In the present embodiment, the first substrate SB1 may be an array substrate. The first substrate SB1 may include a plurality of active elements AD. Specifically, the first substrate SB1 may include a base L1, an insulating layer PV1, a gate G, a gate insulating layer GI, a semiconductor layer SE, a source S, a drain D, an insulating layer PV2, a pixel electrode PE, an insulating layer PV3, a common electrode CE, and an alignment layer 12, but the disclosure is not limited thereto. The plurality of active elements AD may be disposed on a surface S20 of the base L1. One active element AD may include a gate G, a semiconductor layer SE, a source S, and a drain D.

Referring to FIG. 1A and FIG. 1B, in some embodiments, the first substrate SB1 may also include a plurality of scan lines SL and a plurality of data lines DL, wherein the scan lines SL may be electrically connected to the corresponding gates G, and the data lines DL may be electrically connected to the corresponding sources S. In the present embodiment, the plurality of scan lines SL and the plurality of gates G may belong to the same layer, and the plurality of data lines DL, the plurality of sources S, and the plurality of drains D may belong to the same layer. However, the disclosure is not limited thereto. In some embodiments, the extending direction of the plurality of scan lines SL and the extending direction of the plurality of data lines DL may be perpendicular to each other. For example, in the present embodiment, the plurality of scan lines SL are extended toward a first direction (a direction X), and the plurality of data lines DL are extended toward a second direction (a direction Y), but the disclosure is not limited thereto. To simplify the figures, FIG. 1A shows one scan line SL and three data lines DL, but the disclosure is not limited thereto. For convenience of explanation, FIG. 1A shows some elements of the first substrate SB1 and does not show the second substrate SB2. The first direction and the second direction may be different, for example, may be perpendicular.

In some embodiments, the material of the base L1 may include glass, plastic, polymer, or a combination thereof. For example, the material of the base L1 may include quartz, sapphire, silicon (Si), germanium (Ge), silicon carbide (SiC), gallium nitride (GaN), silicon germanium (SiGe), polymethyl methacrylate (PMMA), polycarbonate (PC), polyimide (PI), polyethylene terephthalate (PET), or other suitable materials or a combination of the above materials. The base L1 may be a hard base or a flexible base.

As shown in FIG. 1B, the insulating layer PV1 is disposed, for example, on the surface S20 of the base L1 facing the second substrate SB2. The material of the insulating layer PV1 includes, for example, an organic insulating material, an inorganic insulating material, or a combination thereof. Examples of the organic insulating material include polymethylmethacrylate (PMMA), epoxy, acrylic-based resin, silicone, polyimide polymer, or a combination thereof, but the disclosure is not limited thereto. The inorganic insulating material includes, for example, silicon oxide, silicon nitride, or a combination thereof, but the disclosure is not limited thereto.

The gate G, the semiconductor layer SE, the source S, and the drain D are, for example, disposed on the surface S20 of the base L1 facing the second substrate SB2, and may form the active element AD, for example. In some embodiments, the material of the semiconductor layer SE includes low temperature polysilicon (LTPS), oxide semiconductor, or amorphous silicon (a-Si), but the disclosure is not limited thereto. For example, the material of the semiconductor layer may include, but is not limited to, amorphous silicon, polycrystalline silicon, germanium, compound semiconductor (such as gallium nitride, silicon carbide, gallium arsenide, gallium phosphide, indium phosphide, indium arsenide, and/or indium antimonide), alloy semiconductor (such as SiGe alloy, GaAsP alloy, AlInAs alloy, AlGaAs alloy, GaInAs alloy, GaInP alloy, GaInAsP alloy), or a combination of the above. The material of the semiconductor layer SE may also include, but is not limited to, metal oxide, such as indium gallium zinc oxide (IGZO), indium zinc oxide (IZO), indium gallium zinc oxide (IGZTO), or organic semiconductor containing a polycyclic aromatic compound, or a combination of the above. The gate G is, for example, at least partially overlapped with the semiconductor layer SE in a plan view direction Z of the light control module 10, and a gate insulating layer GI is disposed between the gate G and the semiconductor layer SE. The source S and the drain D are, for example, separated from each other, and may each be electrically connected to the semiconductor layer, but the disclosure is not limited thereto. In the present embodiment, the active element AD may be a bottom gate thin film transistor, but the disclosure is not limited thereto. In other embodiments, the active element AD may be a top gate thin film transistor.

The insulating layer PV2 is, for example, disposed on the active element AD, and has, for example, a through hole TH exposing a portion of the drain D. The insulating layer PV2 may, for example, have the same or similar material as the insulating layer PV1, which is not described again. The pixel electrode PE may be disposed on the insulating layer PV2. The pixel electrode PE may be electrically connected to the drain D via the through hole TH, and electrically connected to the corresponding active element AD.

As shown in FIG. 1A, the light control module 10 includes a plurality of pixel regions 120, the plurality of scan lines SL, and the plurality of data lines DL. The plurality of scan lines SL and the plurality of data lines DL are interleaved. For example, the plurality of scan lines SL may be extended along the first direction X, and the plurality of data lines DL may be extended along the second direction Y. The first direction and the second direction may be different, for example, may be perpendicular. One pixel region 120 may be defined by two adjacent scan lines SL and two adjacent data lines DL. For convenience of explanation, FIG. 1A shows three pixel regions 120, one scan line SL, and three data lines DL. The pixel electrode PE may be disposed in the pixel regions 120.

As shown in FIG. 1B, the pixel electrode PE and the common electrode CE may be disposed on the insulating layer PV2, for example, but the disclosure is not limited thereto. In some embodiments, the material of the pixel electrode PE and the common electrode CE may include metal oxide (such as indium tin oxide), carbon nanotube, graphene, other suitable materials, or a combination thereof, but the disclosure is not limited thereto. In some embodiments, the liquid-crystal molecules in the dielectric layer ML may be driven by providing voltage to the pixel electrode PE and the common electrode CE. In detail, the state of the liquid-crystal molecules in each pixel region of the light control module 10 may be controlled by adjusting the voltage difference between the pixel electrode PE and the common electrode CE, so that the light transmission amount of each pixel region of the light control module 10 may be controlled independently.

The insulating layer PV3 is, for example, disposed between the pixel electrode PE and the common electrode CE. The insulating layer PV3 may, for example, have the same or similar material as the insulating layer PV1, which is not described again.

The alignment layer 12 is, for example, disposed between the insulating layer PV3 and the dielectric layer ML. In some embodiments, the material of the alignment layer 12 may include polyimide, but the disclosure is not limited thereto.

As shown in FIG. 1B, the second substrate SB2 is disposed opposite to the first substrate SB1, for example. In the present embodiment, the second substrate SB2 is a counter substrate, but the disclosure is not limited thereto. In detail, the second substrate SB2 may include a base L2, a light-shielding layer BM, an insulating layer OC, and an alignment layer 14.

The base L2 may, for example, have the same or similar material as the base L1, which is not described again here.

As shown in FIG. 1B, the light-shielding layer BM is disposed, for example, on a surface S40 of the base L2 facing the first substrate SB1. The material of the light-shielding layer BM may include, for example, a light-absorbing material. For example, the material of the light-shielding layer BM may be a black matrix, but the disclosure is not limited thereto. In the present embodiment, the light-shielding layer BM is a patterned light-shielding layer. In detail, the light-shielding layer BM may include a plurality of light-shielding patterns as shown in FIG. 1B. Although FIG. 1B schematically shows one light-shielding pattern, the disclosure is not limited thereto. The light-shielding pattern of the light-shielding layer BM may, for example, be disposed corresponding to the active elements AD, the plurality of scan lines SL, the plurality of data lines DL (shown in FIG. 1A), or other traces. In some embodiments, in the top view direction Z of the light control module 10, the light-shielding layer BM may be at least partially overlapped with the active elements AD, the plurality of scan lines SL, the plurality of data lines DL, or other traces.

The insulating layer OC is, for example, disposed on the surface S40 of the base L2 facing the first substrate SB1, and covers the light-shielding layer BM, for example. The insulating layer OC may, for example, have the same or similar material as the insulating layer PV1, which is not described again.

The alignment layer 14 is, for example, disposed between the insulating layer OC and the dielectric layer ML. The alignment layer 14 may, for example, be made of the same or similar material as the alignment layer 12, which is not described again here. Via the arrangement of the alignment layer 12 and the alignment layer 14, when the light control module 10 is not driven yet, the liquid-crystal molecules in the dielectric layer ML may be aligned according to the rubbing direction of the alignment layer 12 and the alignment layer 14.

The dielectric layer ML is, for example, disposed between the inner surface S2 of the first substrate SB1 and the second substrate SB2. Specifically, the dielectric layer ML is disposed between the inner surface S2 of the first substrate SB1 and the inner surface S4 of the second substrate SB2, and disposed between the alignment layer 12 and the alignment layer 14. In the present embodiment, the dielectric layer ML is a liquid-crystal layer. That is, the material of the dielectric layer ML includes liquid-crystal molecules. In some embodiments, the dielectric layer ML may include electrically-controlled birefringence (ECB) liquid-crystal molecules, vertical alignment (VA) liquid-crystal molecules, or other suitable liquid-crystal molecules, but the disclosure is not limited thereto.

As shown in FIG. 1B, the polarizing element P1 is disposed on the outer surface S1 of the first substrate SB1, for example. In some embodiments, the polarizing element P1 may have a sandwich structure or a laminate structure. For example, the polarizing element P1 may have a polarizing layer (not shown) and a protective layer (not shown) disposed on at least one surface of the polarizing layer. For example, the polarizing element P1 may include a polarizing layer, a first protective layer, and a second protective layer. The first protective layer and the second protective layer are respectively disposed on the upper surface and the lower surface of the polarizing layer. The material of the first protective layer and the second protective layer includes, for example, cellulose triacetate (TAC), but the disclosure is not limited thereto.

The polarizing layer included in the polarizing element P1 is, for example, a film having properties such as light transmission and light deflection. In the present embodiment, the material of the polarizing layer may be a material having a higher polarization degree for a light beam in the wavelength range of 375 nm to 405 nm, so as to improve the polarization degree of the polarizing element P1 for the above wavelength range. For example, in some embodiments, the polarization degree of the polarizing element P1 for a light beam having a wavelength range of 375 nm to 405 nm is 98% to 100%, but the disclosure is not limited thereto. In some embodiments, the polarization degree of the polarizing element P1 for a light beam having a wavelength range of 375 nm to 395 nm is 99.8% to 100%. In some other embodiments, the polarization degree of the polarizing element P1 for a light beam having a wavelength of 385 nm is 99.9% to 100%.

In some embodiments, the material of the polarizing layer includes a dye material and polyvinyl alcohol (PVA), wherein the dye material is, for example, suitable azo dye, phenolphthalein dye, aromatic dye, or a combination thereof. In other words, the polarizing element P1 of the present embodiment may be a dye-based polarizing element. By making the polarizing element P1 of the present embodiment include a dye material, when a light beam having a relatively high energy (for example, a light beam in the wavelength range of 375 nm to 395 nm) passes through the polarizing element P1, the phenomenon of light leakage caused by the light control module 10 when displaying a black screen may be reduced, but the disclosure is not limited thereto. In other embodiments, the polarizing element P1 may be an iodine-based polarizing element.

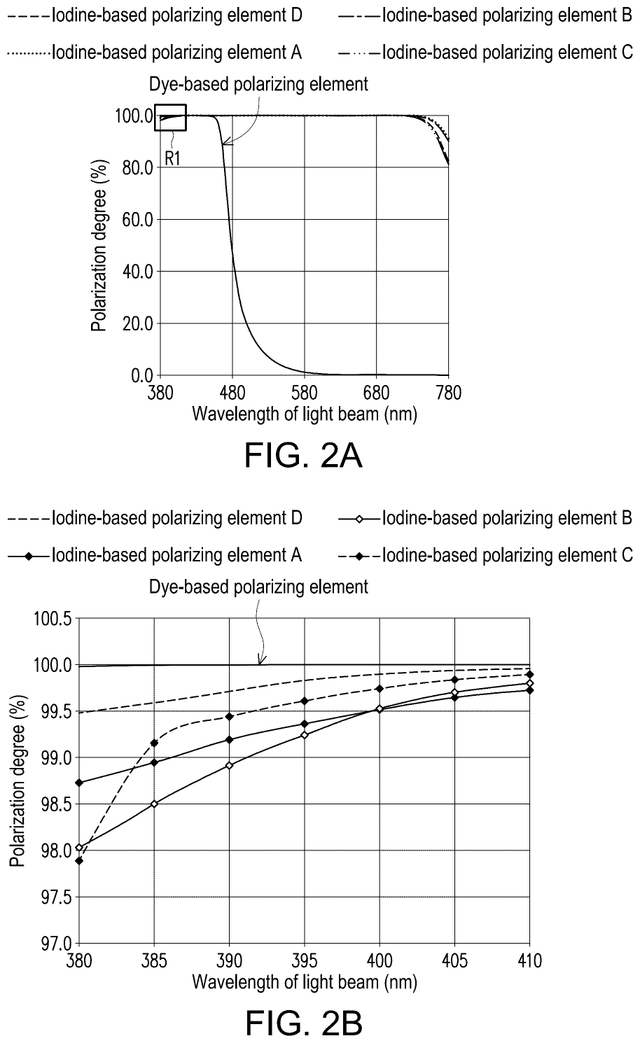

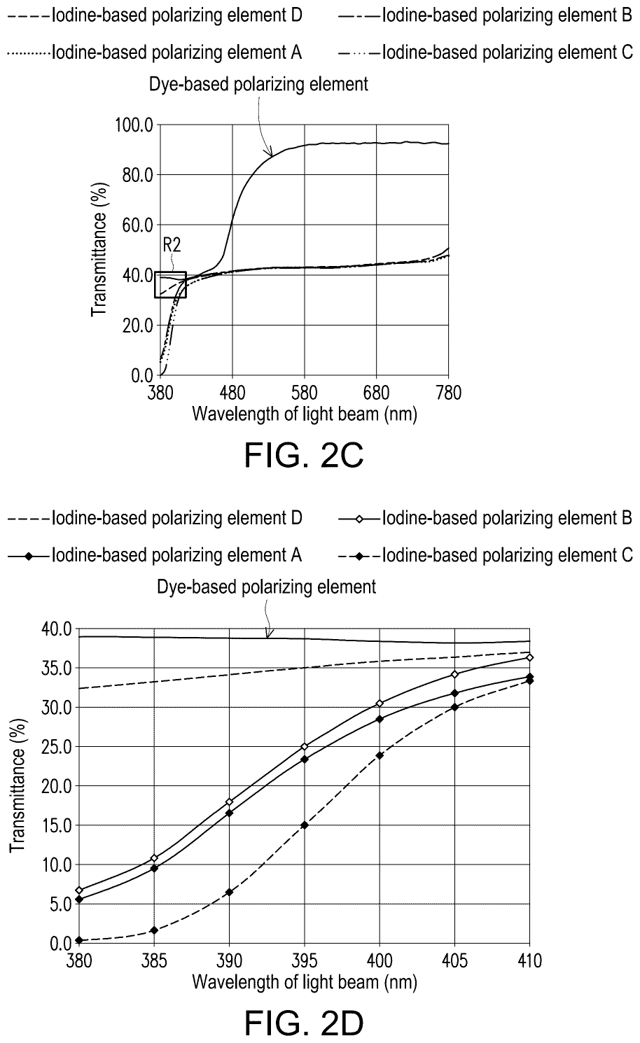

For example, FIG. 2A and FIG. 2B show the polarization degrees of different polarizing elements under light beams of different wavelengths. FIG. 2B is an enlarged schematic view of a region R1 in FIG. 2A. Accordingly, the dye-based polarizing element, an iodine-based polarizing element A, an iodine-based polarizing element B, an iodine-based polarizing element C, and an iodine-based polarizing element D have relatively good polarization degrees in the wavelength range of 380 nm to 410 nm. Therefore, using the three-dimensional printing device 100 including the light control module 10 of the disclosure may achieve good three-dimensional printing effects.

The polarization degree of the polarizing element P1 may be defined, for example, by the following relationship, wherein Pe is the polarization degree of the polarizing element, H0 is the parallel transmittance (the transmittance when the absorption axes of the two polarizing elements are parallel to each other) of the light beam, and H90 is the vertical transmittance (the transmittance when the absorption axes of the two polarizing elements are perpendicular to each other) of the light beam.

$$Pe = \sqrt{\frac{H 0 - H 90}{H 0 + H 90}} \times 100 \%$$

The protective layer is, for example, used to support and protect the polarizing layer to increase the mechanical strength of the polarizing layer. The material of the protective layer may be a material that a light beam in the wavelength range of 375 nm to 405 nm may pass through, so as to improve the transmittance of the polarizing element P1 for the light beam in the above wavelength range. For example, the material of the protective layer may be polyvinyl alcohol triacetyl cellulose (TAC), but the disclosure is not limited thereto. In the present embodiment, by selecting a suitable material as the protective layer, the transmittance of the polarizing element P1 for a light beam of 375 nm to 405 nm is 35% to 50%.

According to some embodiments, the polarization degree of the polarization element suitable for use in a light control module for a light beam having a wavelength range of 375 nm to 405 nm is 98% to 100%. According to some embodiments, the polarization degree of the applicable polarizing element for a light beam having a wavelength range of 380 nm to 400 nm may be 98.5% to 100%, such as 99.2% to 100%, such as 99.5% to 100%. According to some embodiments, the polarization degree of the applicable polarizing element for a light beam having a wavelength range of 380 nm to 395 nm may be 99.2% to 100%, such as 99.5% to 100%. According to some embodiments, the polarization degree of the applicable polarizing element for a light beam having a wavelength range of 382 nm to 390 nm may be 99.5% to 100%, such as 99.7% to 100%.

According to some embodiments, for the polarizing element in the applicable light control module, for a light beam in the wavelength range of 375 nm to 405 nm, the difference in polarization degree may be in the range of 0.0001 to 2. According to some embodiments, for an applicable polarizing element for a light beam in the wavelength range of 380 nm to 395 nm, the difference in polarization degree may be in the range of 0.0001 to 1. For an applicable polarizing element for a light beam in the wavelength range of 382 nm to 390 nm, the difference in polarization degree may be in the range of 0.0001 to 1, for example, in the range of 0.0001 to 0.5, for example, in the range of 0.0001 to 0.01,

For example, FIG. 2C and FIG. 2D show the transmittance of different polarizing elements under light beams of different wavelengths. FIG. 2D is an enlarged view of a region R2 in FIG. 2C. Accordingly, the dye-based polarizing element, the iodine-based polarizing element A, the iodine-based polarizing element B, the iodine-based polarizing element C, and the iodine-based polarizing element D have relatively good transmittance in the wavelength range of 380 nm to 410 nm to reduce the phenomenon of underexposure when the light control module 10 displays a white image. Therefore, using the three-dimensional printing device 100 including the light control module 10 of the disclosure may achieve relatively good three-dimensional printing effects.

According to some embodiments, for the applicable polarizing element in the light control module, the transmittance of a light beam in a wavelengths range of 375 nm to 405 nm may be 10% to 50%, such as 25% to 50%, such as 30% to 50%, such as 35% to 50%. According to some embodiments, the transmittance of the applicable polarizing element for a light beam having a wavelength range of 380 nm to 400 nm may be 25% to 50%, such as 30% to 50%, such as 35% to 50%. According to some embodiments, the transmittance of the applicable polarizing element for a light beam having a wavelength range of 380 nm to 395 nm may be 25% to 50%, such as 30% to 50%, such as 35% to 50%. According to some embodiments, the transmittance of the applicable polarizing element for a light beam having a wavelength range of 382 nm to 390 nm may be 25% to 50%, such as 30% to 50%, such as 35% to 50%, such as 35% to 40%.

The polarization degree and the transmittance of the polarizing element P1 may be measured using a spectrophotometer (such as JASCO V-7100), but the disclosure is not limited thereto. The measurement method of the polarizing element P1 may be, for example, first operating a spectrophotometer to make the incident light enter the linear polarizer to form linearly polarized light. When this linearly polarized light enters the sample to be measured (the polarizing element P1 to be measured), by rotating at different angles, the optical properties (such as absorption axis angle, polarization degree, transmittance) of the sample to be measured (the polarizer to be measured) may be obtained.

In some embodiments, the polarizing element P1 may be directly attached to the outer surface S1 of the first substrate SB1 via an adhesive layer (not shown). In other words, the adhesive layer may be in direct contact with the outer surface S1 of the first substrate SB1. In some embodiments, the adhesive layer may adopt an antistatic pressure sensitive adhesive (AS-PSA). In some embodiments, the sheet resistance of the adhesive layer used to bond the polarizing element P1 to the first substrate SB1 may be between 1×10¹¹ Ω/Y and 1×10¹⁴ Ω/Y, or may be between 2×10¹¹ Ω/Y and 1×10¹³ Ω/Y, but the disclosure is not limited thereto.

As shown in FIG. 1B, in the present embodiment, the light control module 10 may further include a polarizing element P2. The polarizing element P2 is, for example, disposed on the outer surface S3 of the second substrate SB2 away from the first substrate SB1. The outer surface S3 of the second substrate SB2 may be a surface away from the first substrate SB1, and the inner surface S4 may be a surface facing the first substrate SB1.

The structure included in the polarizing element P2 and the material thereof may each be the same as or similar to the structure included in the polarizing element P1 and the material thereof and are not described again. In some embodiments, the polarizing element P2 may also be directly attached to the outer surface S3 of the second substrate SB2 away from the first substrate SB1 via an adhesive layer (not shown). The adhesive layer used to bond the polarizing element P2 to the second substrate SB2 may, for example, be different from the adhesive layer used to bond the polarizing element P1 to the first substrate SB1. In the present embodiment, the sheet resistance of the adhesive layer may be designed to have low impedance. That is, the sheet resistance of the adhesive layer used to bond the polarizing element P2 to the second substrate SB2 may be less than the sheet resistance of the adhesive layer used to bond the polarizing element P1 to the first substrate SB1. For example, the sheet resistance of the adhesive layer used to bond the polarizing element P2 and the second substrate SB2 may be in the range of 1×10⁸ Ω/Y to 1×10¹² Ω/Y, for example, in the range of 1×10⁸ Ω/Y to 1×10¹¹ Ω/Y, or in the range of 1×10⁸ Ω/Y to 1×10¹⁰ Ω/Y, for example. Accordingly, the adhesive layer may further provide electrostatic protection for the elements (such as the second substrate SB2, the first substrate SB1, and the dielectric layer ML) therebelow, and the light control module 10 does not need to provide an additional layer of transparent conductive layer for antistatic between the polarizing element P1 and the first substrate SB1, thus helping to improve the light transmittance of the light control module 10 and reduce the risk of underexposure.

FIG. 3A, FIG. 4A, and FIG. 5A are respectively a flowchart of an operation method of a three-dimensional printing device according to one embodiment of the disclosure. FIG. 3B, FIG. 4B, and FIG. 5B are respectively a top schematic view of a display image of the light control modules in FIG. 3A, FIG. 4A, and FIG. 5A.

As shown in FIG. 3A, the three-dimensional printing device 100 may include the light control module 10, the light source module 20, and the receiving slot 30. The light source module 20 is used to provide a light beam B to the light control module 10. The receiving slot 30 is used to receive a photo-curing material 32, and the photo-curing material 32 may be cured by the light beam B. The light control module 10 is disposed between the light source module 20 and the receiving slot 30.

In some embodiments, the light source module 20 is, for example, a UV light source module. In detail, the wavelength range of the light beam provided by the light source module 20 may be, for example, between 100 nm and 420 nm. In some embodiments, the wavelength range of the light beam provided by the light source module 20 is between 300 nm and 420 nm, but the disclosure is not limited thereto. In some embodiments, the wavelength range of the light beam provided by the light source module 20 is between 375 nm and 395 nm. In some other embodiments, the wavelength of the light beam provided by the light source module 20 may be 385 nm.

In the present embodiment, the three-dimensional printing device 100 may also include a light condensing element (not shown) and a heat dissipation element (not shown), but the disclosure is not limited thereto.

The light condensing element is disposed between the light control module 10 and the light source module 20, for example, so as to centrally provide the light beam provided by the light source module 20 to the light control module 10. In some embodiments, the light condensing element may include a condenser lens and a Fresnel lens, but the disclosure is not limited thereto.

The heat dissipation element is, for example, disposed at a side of the light source module 20 away from the light control module 10, for example, to absorb and/or dissipate heat generated from the light source module 20. In some embodiments, the heat dissipation element 50 may include a heat sink and a fan, but the disclosure is not limited thereto. The heat dissipation fin may, for example, have a plurality of heat dissipation fins, and the plurality of heat dissipation fins may be extended along a direction close to the fan, but the disclosure is not limited thereto.

Referring to FIG. 3A and FIG. 3B, in the present embodiment, the operation method of the three-dimensional printing device 100 may include the following steps. The three-dimensional printing device 100 is provided; the photo-curing material 32 is disposed in the receiving slot 30; the light source module 20 is made to provide the light beam B; the light control module 10 is made to provide a first light-transmitting area RT1 and a first light-shielding area RB1; the light beam B is made to pass through the first light-transmitting area RT1 of the light control module 10; and the first portion of the photo-curing material 32 corresponding to the first light-transmitting area RT1 is cured into a first cured layer 32-1 via the light beam B. In FIG. 3A, FIG. 4A, and FIG. 5A, uncured and cured photo-curing materials 32 are marked with different mesh bases for easy identification. The uncured portion is denoted as an uncured layer 32-0, and the cured portion is denoted as the first cured layer 32-1. For the light control module 10, reference may be made to the above description which is not described again here.

Referring to FIG. 1A and FIG. 3B simultaneously, the light control module 10 may include the plurality of pixel regions 120. The light-transmitting area and the light-shielding area may be provided by adjusting the voltages of the pixel electrodes PE of different areas in the plurality of pixel regions. In detail, for example, FIG. 3B shows a plurality of pixel regions, a first voltage may be provided to the pixel electrodes in a portion of the pixel regions, a second voltage may be provided to the pixel electrodes in another portion of the pixel regions, and the first voltage is not equal to the second voltage. In this way, the region to which the first voltage is provided may be the first light-transmitting area RT1, and the area to which the second voltage is provided may be the first light-shielding area RB1. Specifically, the state of the liquid-crystal molecules in each pixel region may be controlled by adjusting the voltage difference between the pixel electrode and the common electrode (not shown), thereby independently controlling the light transmission amount of each pixel region in the light control module 10. For example, a plurality of pixel regions of the middle region in the light control module 10 may be made to present a white image (transparent state), which may be the first light-transmitting area RT1. A plurality of pixel regions of the peripheral region present a black image (light-shielding state), which may be the first light-shielding area RB1. In particular, the greater the quantity of pixel regions presenting a white image, the greater the light-transmitting area; conversely, the greater the quantity of pixel regions presenting a black image, the less the light-transmitting area and the greater the light-shielding area.

Referring to FIG. 4A and FIG. 4B, in some embodiments, the operation method of the three-dimensional printing device 100 may further include the following steps. Similarly, the light control module 10 is made to provide the second light-transmitting area RT2 and the second light-shielding area RB2; the light beam B is made to pass through the second light-transmitting area RT2 of the light control module 10; and the second portion of the photo-curing material 32 corresponding to the second light-transmitting area RT2 is cured into a second cured layer 32-2 via the light beam B, and the second cured layer 32-2 is stacked on the first cured layer 32-1.

Referring to FIG. 5A and FIG. 5B, in some embodiments, the operation method of the three-dimensional printing device 100 may further include the following steps. Similarly, the light control module 10 is made to provide a third light-transmitting area RT3 and a third light-shielding area RB3; the light beam B is made to pass through the third light-transmitting area RT3 of the light control module 10; and the third portion of the photo-curing material 32 corresponding to the third light-transmitting area RT3 is cured into a third cured layer 32-3 via the light beam B, and the third cured layer 32-3 is stacked on the second cured layer 32-2.

For convenience of explanation, the forming method of the three cured layers 32-1, 32-2, and 32-3 are described. As shown in FIG. 5B, there are other cured layers between the first cured layer 32-1 and the second cured layer 32-2. There are other cured layers between the second cured layer 32-2 and the third cured layer 32-3. For the forming method of other cured layers, reference may also be made to the above method of the first cured layer 32-1, which is not described again here.

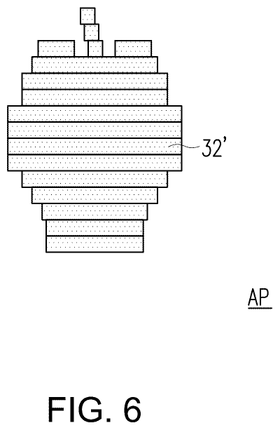

Specifically, taking the three-dimensional printing of one Apple AP as shown in FIG. 6 as an example, a carrier CA used to carry the three-dimensional printed product (i.e., Apple AP) may be placed in the unilluminated photo-curing material 32. Then, the size of the light-transmitting area/light-shielding area in the light control module 10 allowing the light beam B to pass through is adjusted electronically, so that a cured layer 32′ is formed by curing the liquid photo-curing material 32 in the receiving slot 30 overlapped with the light-transmitting area and located under the carrier CA.

After the cured layer 32′ is formed, if the production of the Apple AP is not completed, the carrier CA may be lifted a certain distance. The distance is equal to the thickness of the cured layer 32′ to be formed by a subsequent curing step. After a plurality of curing steps, the plurality of cured layers 32′ may be stacked into a three-dimensional pattern. After the production of the Apple AP is completed, the curing process may be terminated and the Apple AP may be separated from the carrier CA to obtain the Apple AP as shown in FIG. 6. Specifically, the completed three-dimensional apple pattern may include a stack of plurality of cured layers, for example, may include the cured layers 32-1, 32-2, and 32-3, but the disclosure is not limited thereto.

Based on the above, in the three-dimensional printing device, the light control module, and the operation method of the three-dimensional printing device of some embodiments of the disclosure, the polarizing element may have relatively good polarization degree for a light beam having a relatively high energy (such as a light beam having a wavelength of 385 nm) to reduce the phenomenon of light leakage caused by the light control module when displaying a black screen, so that a product printed by the three-dimensional printing device of the disclosure may have relatively good quality. Accordingly, the three-dimensional printing device of the disclosure may shorten the printing time of the product by printing using a relatively high-energy light beam.

What is claimed is:

1. A three-dimensional printing device, comprising:
a light control module;
a light source module used to provide a light beam to the light control module; and
a receiving slot used to receive a photo-curing material, wherein the light control module is disposed between the light source module and the receiving slot, and the photo-curing material is cured by the light beam;
wherein the light control module comprises:
a first substrate having an outer surface and an inner surface opposite to the outer surface;
a second substrate opposite to the first substrate;
a dielectric layer disposed between the inner surface of the first substrate and the second substrate; and
a polarizing element disposed on the outer surface of the first substrate,
wherein a polarization degree of the polarizing element for a light beam having a wavelength range of 375 nm to 405 nm is 98% to 100%.

2. The three-dimensional printing device of claim 1, wherein a transmittance of the polarizing element for a light beam having a wavelength range of 375 nm to 405 nm is 35% to 50%.

3. The three-dimensional printing device of claim 1, wherein the polarizing element comprises a dye material.

4. The three-dimensional printing device of claim 1, wherein the light source module is used to provide a light beam having a wavelength range of 300 nm to 420 nm.

5. The three-dimensional printing device of claim 4, wherein the light source module is used to provide a light beam having a wavelength range of 375 nm to 395 nm.

6. The three-dimensional printing device of claim 1, wherein the polarization degree of the polarizing element for a light beam having a wavelength range of 375 nm to 395 nm is 99.8% to 100%.

7. The three-dimensional printing device of claim 1, wherein the polarization degree of the polarizing element for a light beam having a wavelength range of 385 nm is 99.9% to 100%.

8. The three-dimensional printing device of claim 1, wherein the dielectric layer comprises a liquid-crystal layer.

9. A light control module, comprising:
a first substrate having an outer surface and an inner surface opposite to the outer surface;
a second substrate opposite to the first substrate;
a dielectric layer disposed between the inner surface of the first substrate and the second substrate; and
a polarizing element disposed on the outer surface of the first substrate,
wherein a polarization degree of the polarizing element for a light beam having a wavelength range of 375 nm to 405 nm is 98% to 100%.

10. The light control module of claim 9, wherein a transmittance of the polarizing element for a light beam having a wavelength range of 375 nm to 405 nm is 35% to 50%.

11. The light control module of claim 9, wherein the polarizing element comprises a dye material.

12. The light control module of claim 9, wherein the polarization degree of the polarizing element for a light beam having a wavelength range of 375 nm to 395 nm is 99.8% to 100%.

13. The light control module of claim 9, wherein the polarization degree of the polarizing element for a light beam having a wavelength range of 385 nm is 99.9% to 100%.

14. The light control module of claim 9, wherein the dielectric layer comprises a liquid-crystal layer.

15. An operation method of a three-dimensional printing device, comprising:
providing a three-dimensional printing device, wherein the three-dimensional printing device comprises a light control module, a light source module, and a receiving slot, the light control module comprises a first substrate, a second substrate, a dielectric layer, and a polarizing element, the first substrate has an outer surface and an inner surface opposite to the outer surface, the second substrate is disposed opposite to the first substrate, the dielectric layer is disposed between the inner surface of the first substrate and the second substrate, the polarizing element is disposed on the outer surface of the first substrate, and a polarization degree of the polarizing element for a light beam having a wavelength range of 375 nm to 405 nm is 98% to 100%;
disposing a photo-curing material in the receiving slot;
making the light source module provide a light beam;
making the light control module provide a first light-transmitting area and a first light-shielding area;
making the light beam pass through the first light-transmitting area of the light control module; and
curing a first portion of the photo-curing material corresponding to the first light-transmitting area into a first cured layer via the light beam.

16. The operation method of the three-dimensional printing device of claim 15, further comprising:
making the light control module provide a second light-transmitting area and a second light-shielding area;
making the light beam pass through the second light-transmitting area of the light control module; and
curing a second portion of the photo-curing material corresponding to the second light-transmitting area into a second cured layer via the light beam, and stacking the second cured layer on the first cured layer.

17. The operation method of the three-dimensional printing device of claim 15, wherein the light control module comprises a plurality of pixel regions, and the operation method further comprises:
making the light control module provide the first light-transmitting area and the first light-shielding area by adjusting a voltage of a pixel electrode in the plurality of pixel regions.

18. The operation method of the three-dimensional printing device of claim 17, wherein the first light-transmitting area of the light control module presents a white image, and the first light-shielding area presents a black image.

19. The operation method of the three-dimensional printing device of claim 15, wherein the polarization degree of the polarizing element for a light beam having a wavelength range of 375 nm to 395 nm is 99.8% to 100%.

20. The operation method of the three-dimensional printing device of claim 15, wherein the polarization degree of the polarizing element for a light beam having a wavelength range of 385 nm is 99.9% to 100%.
